(19) United States
(12) Patent Application Publication
(10) Pub. No.: US 2002/0029091 A1
(43) Pub. Date: Mar. 7, 2002

(54) Digital audio player capable of playing digital audio data through existing cassette tape player

(75) Inventors: Koichi Seno, Yamagata-shi (JP); Yoshimi Hanaika, Murayama-shi (JP); Makoto Sato, Nishimurayama-gun (JP)

Correspondence Address: FRISHAUF, HOLTZ, GOODMAN, LANGER & CHICK, P.C., 25th Floor, 767 Third Avenue, New York, NY, 10017, US

(73) Assignee: Mitsumi Electric Co. Ltd., Tokyo (JP)

(21) Appl. No.: 09/947,040

(22) Filed: Sep. 5, 2001

(30) Foreign Application Priority Data
Sep. 6, 2000 (JP) 269620/2000

(51) Int. Cl. G06F 17/00

(52) U.S. Cl. 700/94

(57) ABSTRACT

A digital audio player comprises a semiconductor memory device for rewritably recording digital audio data and a digital audio reproducing unit for converting the digital audio data into analogue audio data and for reproducing the analogue audio data. The digital audio player comprises a casing which has the same shape as that of a cassette tape and which contains the semiconductor memory device and the digital audio reproducing unit. The digital audio reproducing unit comprises a digital/analogue converter for converting the digital audio data recorded in the semiconductor memory device into the analogue audio data and an output head for outputting the analogue audio data converted by the digital/analogue converter to a reproducing head of a cassette tape player for reproducing the analogue audio data recorded in the cassette tape.

### BACKGROUND OF THE INVENTION

This invention relates to a digital audio player used for reproducing digital audio data through a cassette tape player widely popularized for reproducing analogue audio data from a cassette tape as a recording medium for recording analogue data.

Recently, the digital audio player for reproducing or playing the digital audio data recorded in a semiconductor memory device through a speaker or a headphone is spreading. The digital audio data is recorded by the use of such compression encoding format as an MP3 (MPeg (MPEG: Motion Picture Expert Group) audio layer 3). Particularly, the digital audio player of portable type such as to be provided with a battery and play the digital audio data through the headphone.

However, the cassette tape player only for the cassette tape is still major as an audio player used in a home or a car of a consumer. Furthermore, the possession number of the cassette tape player for each consumer or for each home may be plural.

Therefore, all the cassette tape players of the consumer are never changed into the digital audio player for a while. In other words, it may be necessary for changing a large number of the cassette tape players into the digital audio players of high cost and a long time.

After a CD (Compact Disc) using a CD-DA (CD-Digital Audio) format began to be saturated, an adapter for playing the audio data from such CD player of the portable type through such cassette tape player of a mobile type (so called as a cassette car stereo set) is developed and now used popularly.

The adapter has a casing which has the same shape as that of the cassette tape, an output head, and a cable having a plug connector. The output head is arranged in the casing and can output analogue audio data to a playing head of the cassette tape player by using electromagnetic induction. The plug connector can stick in a socket connector of the CD player or the like. Thus, the cable can connect between the output head and the CD player through the plug connector.

It is not to say that the adapter can be connected to not only the CD player but also the digital audio player. The adapter is really connected to the digital audio player of the portable type and the digital audio data can be played through the cassette car stereo set. Furthermore, by using the adapter, the audio data from such MD (Mini Disc) player and LCD (Liquid Crystal Display) television set of the portable type can be also played through the cassette car stereo set.

However, wiring operation for connecting between the digital audio player and the adapter is really hard and troublesome and it is really difficult to secure a space for arranging the digital audio player wiring with the wiring mentioned above in the car.

### SUMMARY OF THE INVENTION

It is therefore an object of this invention to provide a digital audio player capable of playing digital audio data through an existing cassette tape player, of cutting down troublesome wiring work for connecting between the cassette tape player and the digital audio player, and of leaving out a space for arranging the digital audio player.

The other objects, features, and advantages of this invention will become clear as the following description proceeds.

A digital audio player to which this invention comprises a semiconductor memory device for rewritably recording digital audio data and a digital audio reproducing unit for converting the digital audio data into analogue audio data and for reproducing the analogue audio data. The digital audio player comprises a casing which has the same shape as that of a cassette tape and which contains the semiconductor memory device and the digital audio reproducing unit. The digital audio reproducing unit comprises a digital/analogue converter for converting the digital audio data recorded in the semiconductor memory device into the analogue audio data and an output head for outputting the analogue audio data converted by the digital/analogue converter to a reproducing head of a cassette tape player for reproducing the analogue audio data recorded in the cassette tape.

According to an aspect of this invention, the digital audio player further comprises a self electric-generation unit contained in the casing. The self electric-generation unit generates electric power by electromagnetic induction caused by driving power of a motor which is provided in the cassette tape player for driving a hub or a tape of the cassette tape, said self electric-generation unit supplying electric power to the digital audio reproducing unit.

According to the other aspect of this invention, the digital audio player further comprises a digital audio recording unit for converting the analogue audio data into the digital audio data and for recording the digital audio data in the semiconductor memory device. The digital audio recording unit comprises an erasing instruction detecting head for detecting as an erasing instruction signal an erasing signal which is for use in erasing the analogue audio data recorded in the cassette tape and which is generated by an erasing head provided in a cassette tape recorder, an input head for receiving the analogue audio data which should be recorded in the cassette tape and which are produced by a recording head provided in the cassette tape recorder, and an analogue/digital converter, when the erasing instruction detecting head detects the erasing instruction signal, for converting the analogue audio data from the input head into the digital audio data and for recording the digital audio data in the semiconductor memory device.

### BRIEF DESCRIPTION OF THE DRAWINGS

FIG. 1 is a block diagram showing a structure of a digital audio player according to a first embodiment of this invention; and

FIG. 2 is a block diagram showing a structure of a digital audio player according to a second embodiment of this invention.

### DESCRIPTION OF THE PREFERRED EMBODIMENTS

Now, preferred embodiment of this invention will be described with reference to drawings.

First Embodiment

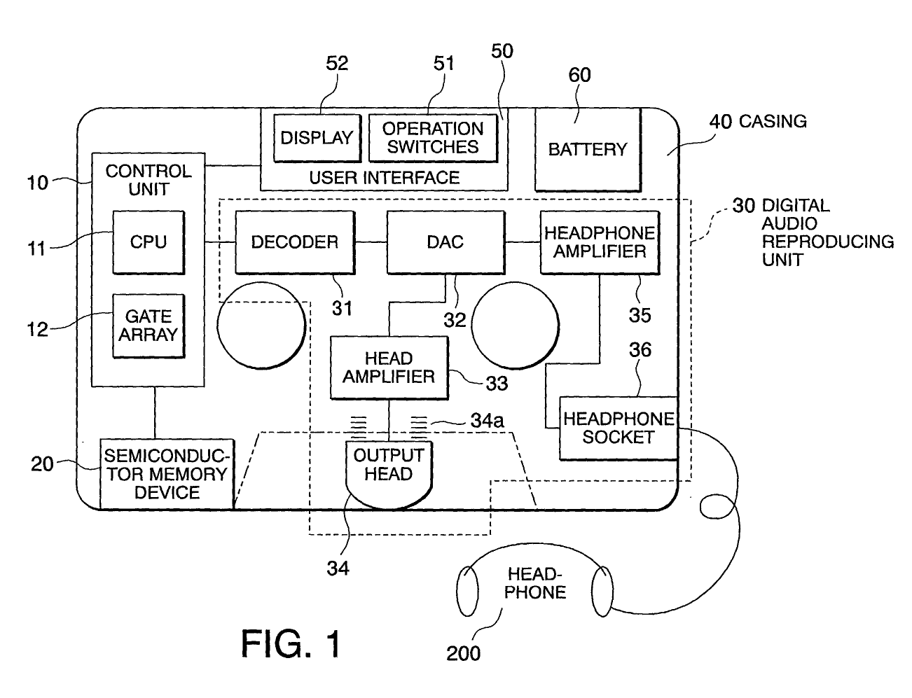

Referring to FIG. 1, a digital audio player according to a first embodiment of this invention has, as like to the conventional digital audio player of a portable type, a semiconductor memory device 20 for rewritably recording digital audio data and a digital audio reproducing unit 30 for for converting the digital audio data recorded in the semiconductor memory device 20 into analogue audio data and reproducing the analogue audio data.

The digital audio player further has a casing 40 having the same shape and size as those of a conventional cassette tape and which contains the semiconductor memory device 20 and the digital audio reproducing unit 30.

Furthermore, the digital audio player has a control unit 10 for totally controlling the operations of the digital audio player. The control unit 10 has a CPU (Central Processing Unit) 11 and a gate array 12.

The digital audio reproducing unit 30 has a decoder 31, a DAC (Digital/Analogue Converter) 32, a head amplifier 33, and an output head 34.

The decoder 31 decompresses and decodes the digital audio data (compressed and encoded by an MP3 format) recorded in the semiconductor memory device 20. The DAC 32 converts the digital audio data decompressed and decoded into the analogue audio data. The head amplifier 33 amplifies the analogue audio data so that the output head 34 sufficiently responds to the analogue audio data.

The output head 34 outputs the analogue audio data converted by the DAC 32 and amplified by the head amplifier 33 to a reproducing head of the cassette tape player (not shown) for reproducing the analogue audio data recorded in the cassette tape. To be more concrete, the output head 34 has an approximate structure to a recording head of a cassette tape recorder for recording the digital audio data to the cassette tape. The output head 34 is provided with a suspension 34a for suspending the output head 34 on the casing 40 so that the output head 34 moves with corresponding to the reproducing head of the cassette tape player and is positioned at an applicable position to the reproducing head.

The semiconductor memory device 20 may be a card type standardized in shape, size, and electric circuit such as Smart media, Compact flash, Memory stick, and Multimedia card. Furthermore, the semiconductor memory device 20 may be a type memorized an ID data therein. The semiconductor memory device 20 is contained in the casing 40 so as to be removable from the casing 40.

The digital audio player further has a battery 60, contained in the casing 40, supplying electric power to the control unit 10 and the digital audio reproducing unit 30. The battery 60 may be a dry cell type or a rechargeable cell type. In FIG. 1, wirings between the battery 60 and portions to be supplied with the electric power from the battery 60 are omitted in drawing. The battery 60 may be contained in the casing 40 so as to be removable from the casing 40. Consequently, if the battery 60 is rechargeable and removable from the casing 40, the battery 60 removed from the casing 40 is individually charged by an exclusive battery charger. On the other hand, if the battery 60 is rechargeable and not removable from the casing 40, the battery 60 contained in the casing 40 is charged by a battery charger through a wiring (not shown) connecting the battery charger and the digital audio player. If the battery 60 is also rechargeable and not removable from the casing 40, the battery 60 contained in the casing 40 may be charged by the battery charger in a condition that the casing 40 is put on a cradle (not shown) for holding the casing therein.

In order to digitally and rewritably record the digital audio data to the semiconductor memory device 20, the digital audio player may further have a digital data interface (not shown). The digital data interface is contained in the casing 40, interfacing between the digital audio player (the semiconductor memory device 20) and an electric apparatus such as a personal computer and a portable cellular phone. For example, the digital data interface is a USB (Universal Serial Bus) interface or an IEEE1394 (Institute of Electrical and Electronics Engineers 1394) interface.

Furthermore, the digital audio player further has a headphone amplifier 35, a headphone socket 36, and a user interface 50 contained in the casing 40.

The headphone amplifier 35 amplifies the analogue audio data converted by the DAC 32 so that a headphone 200 sufficiently respond to the analogue audio data. The headphone socket 36 makes the headphone 200 removably connecting to the digital audio player and interfaces between the headphone amplifier 35 and the headphone 200 so that the analogue audio data are output to the headphone 200.

The user interface 50 serves to operate various operations of the digital audio player by the user of the digital audio player. Namely, the user interface 50 is provided with operation switches 51 and a display 52. The operation switches 51 controls various operation such as power on/off, audio play, audio stop, track selection, audio fast-forward and audio rewind, volume adjusting. The display 52 is structured by such as a liquid crystal display and displays various informations such as track number, playing time, track title, and battery capacity. Thus, the digital audio player can be, as like to the conventional digital audio player of the portable type, used (play audio through the headphone 200) independently from the cassette tape player.

When the digital audio player having a structure that has been described above is inserted in the cassette tape player such as the car stereo set instead of the cassette tape, the digital audio data recorded in the semiconductor memory device 20 are reproduced or played through an amplifier and a speaker or a headphone of the cassette audio player.

Second Embodiment

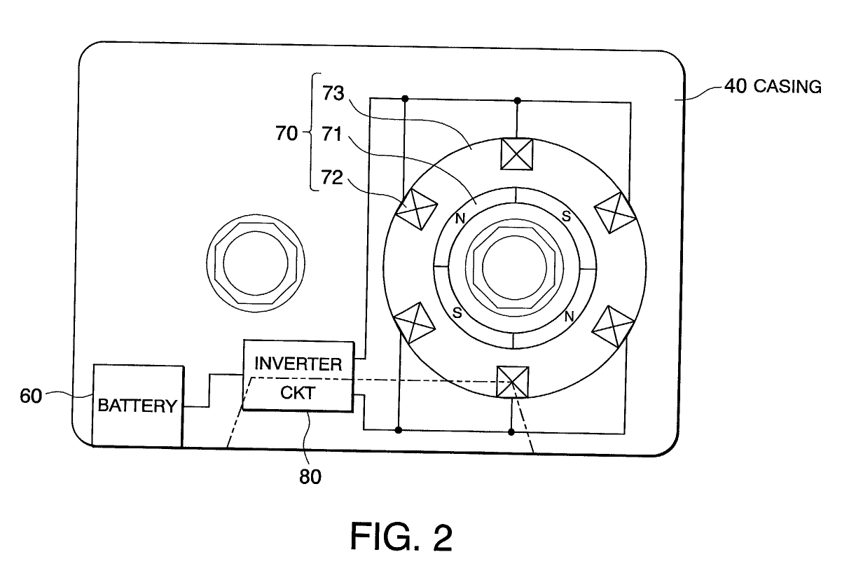

Referring to FIG. 2, a digital audio player according to a second embodiment of this invention has, as like to the digital audio player of the first embodiment, the semiconductor memory device, the digital audio reproducing unit, the casing 40 having the same shape and size as those of the conventional cassette tape, the control unit provided with the CPU and the gate array, the battery 60 contained in the casing 40 for supplying the electric power to the control unit and the digital audio reproducing unit, and the user interface provided with the operation switches and the display. Parts provided with no symbol in the description mentioned above are also omitted in drawing in FIG. 2. The digital audio reproducing unit also has, as like to the first embodiment, the decoder, the DAC, the head amplifier, the output head provided with the suspension, the headphone amplifier, and the headphone socket.

Furthermore, the digital audio player has a self electric-generation unit contained in said casing 40. The self electric-generation unit generates electric power by electromagnetic induction caused by driving power of a motor (not shown), provided in the cassette tape player, for driving a hub or a tape of the cassette tape and supplies electric power to the control unit and the digital audio reproducing unit 30.

In the second embodiment, the motor of the cassette tape player is that for driving the hub. Although the self electric-generation unit can supply the electric power to the control unit and the digital audio reproducing unit 30 any directly or indirectly through the battery 60, the self electric-generation unit in the second embodiment supplies as the latter.

The self electric-generation unit has an electric-generator 70 and an inverter circuit 80. The electric-generator 70 is provided with a hub portion having an annular shape and is rotatably arranged in the casing 40, a permanent magnet 71 having an annular shape and is attached to the hub portion, a core 73 having an annular shape and is rigidly attached to the casing 40 around the hub portion, and a plurality of coils 72 annularly attached to the core 73 so as to surround the permanent magnet 71. Lead wires of the coils 72 are connected to an input port of the inverter circuit 80. An output port of the inverter 80 is connected to the battery.

When the digital audio player having a structure that has been described above is inserted in the cassette tape player such as the car stereo set instead of the cassette tape, the digital audio data recorded in the semiconductor memory device are reproduced through the amplifier and the speaker or the headphone of the cassette audio player. Furthermore, the permanent magnet 71 is rotated with the hub portion by the motor for driving the hub of the cassette tape player. Consequently, the coils 72 generates electric current by the electromagnetic induction. The electric current is converted to voltage by the inverter 80. The electric power from the inverter 80 is supplied to the battery. Thus, frequency of replacement of and/or charge on the battery 60 can be reduced.

Third Embodiment

A digital audio player according to a third embodiment of this invention also has, as like to the digital audio player of the first or the second embodiment, the semiconductor memory device, the digital audio reproducing unit, the casing having the same shape and size as those of the conventional cassette tape, the control unit provided with the CPU and the gate array, the battery contained in the casing for supplying the electric power to the control unit and the digital audio reproducing unit, and the user interface provided with the operation switches and the display.

Furthermore, the digital audio player has a digital audio recording unit, contained in the casing, for for converting the analogue audio data into the digital audio data and for recording the digital audio data in the semiconductor memory device.

The digital audio recording unit has an erasing instruction detecting head, an input head, a ADC (analogue to digital converter), an erasing instruction detecting head, and an encoder.

The erasing instruction detecting head detects as an erasing instruction signal an erasing signal which is for use in erasing the analogue audio data recorded in the cassette tape and which is generated by an erasing head provided in a cassette tape recorder. The input head inputs the analogue audio data output, for recording the digital audio data in the cassette tape, from a recording head provided in the cassette tape recorder. The ADC converts the analogue audio data from the input head into the digital audio data. The encoder compresses and encodes the digital audio data by the MP3 format to be record in the semiconductor memory device.

When the erasing instruction detecting head detects the erasing instruction signal, the ADC converts the analogue audio data from the input head into the digital audio data and the encoder compresses and encodes the digital audio data. Thus, the analogue audio data are record as the digital audio data in the semiconductor memory device.

The output head may serve double duty as the input head. However, the digital audio player must comprise a switching circuit for switching which the analogue audio data are transmitted to the output head or from the input head. The DAC can also serve double duty as a part or all parts of the ADC.

When the digital audio player having a structure that has been described above is inserted in the cassette tape recorder instead of the cassette tape, the analogue audio data are converted into the digital audio data and recorded in the semiconductor memory device. For example, when the digital audio player is inserted in the cassette tape recorder having such audio source as the CD, radio, and a microphone, the audio data from the CD, the radio, or the microphone can be recorded in the semiconductor memory device.

While this invention has thus far been described in conjunction with the embodiments thereof, it will readily be possible for those skilled in the art to put this invention into practice in various other manners. For example, the shape and the size of the casing of the digital audio player is not limited to only the cassette tape and therefore may be another analogue recording medium such as a micro-cassette tape. Furthermore, the semiconductor memory device of the digital audio player is not limited to only the semiconductor type and therefore may be another digital memory device such as a hard disk drive.

What is claimed is:

1. A digital audio player comprising a semiconductor memory device for rewritably recording digital audio data and a digital audio reproducing unit for converting the digital audio data into analogue audio data and for reproducing the analogue audio data;
wherein said digital audio player comprises a casing which has the same shape as that of a cassette tape and which contains said semiconductor memory device and said digital audio reproducing unit;
said digital audio reproducing unit comprising a digital/analogue converter for converting the digital audio data recorded in said semiconductor memory device into the analogue audio data and an output head for outputting the analogue audio data converted by said digital/analogue converter to a reproducing head of a cassette tape player for reproducing the analogue audio data recorded in the cassette tape.

2. A digital audio player as claimed in claim 1, wherein said semiconductor device is standardized so as to have a card shape and is removable from said casing.

3. A digital audio player as claimed in claim 1, wherein said digital audio player further comprises a battery contained in said casing, said battery supplying electric power to said digital audio reproducing unit.

4. A digital audio player as claimed in claim 3, wherein said battery is removable from said casing.

5. A digital audio player as claimed in claim 1, wherein said digital audio player further comprises a digital data interface contained in said casing, said digital data interface interfacing between said semiconductor memory device and an electric apparatus for digitally and rewritably recording the digital audio data to said semiconductor memory device.

6. A digital audio player as claimed in claim 1, wherein said digital audio player further comprises a headphone socket and a user interface contained in said casing, said headphone socket interfacing between said digital/analogue converter and a headphone so that the analogue audio data converted by said digital/analogue converter are output to the headphone, said user interface serving to operate various operations of said digital audio player by the user of said digital audio player.

7. A digital audio player as claimed in claim 1, wherein said digital audio player further comprises a self electric-generation unit contained in said casing, said self electric-generation unit generating electric power by electromagnetic induction caused by driving power of a motor which is provided in the cassette tape player for driving a hub or a tape of the cassette tape, said self electric-generation unit supplying electric power to said digital audio reproducing unit.

8. A digital audio player as claimed in claim 3, wherein said self electric-generation unit indirectly supplies the electric power to said digital audio reproducing unit through the battery.

9. A digital audio player as claimed in claim 1, wherein said digital audio player further comprises a digital audio recording unit for converting the analogue audio data into the digital audio data and for recording the digital audio data in said semiconductor memory device;
said digital audio recording unit comprising:
an erasing instruction detecting head for detecting as an erasing instruction signal an erasing signal which is for use in erasing the analogue audio data recorded in the cassette tape and which is generated by an erasing head provided in a cassette tape recorder;
an input head for receiving the analogue audio data which should be recorded in the cassette tape and which are produced by a recording head provided in the cassette tape recorder; and
an analogue/digital converter, when said erasing instruction detecting head detects said erasing instruction signal, for converting the analogue audio data from said input head into the digital audio data and for recording the digital audio data in said semiconductor memory device.
